(19) United States
(12) Patent Application Publication
(10) Pub. No.: US 2018/0334396 A1
(43) Pub. Date: Nov. 22, 2018

(54) Defined Carbon Porosity for Sustainable Capacitive Charging

(71) Applicant: PowerTech Water LLC, Lexington, KY (US)

(72) Inventors: Cameron Lippert, Lexington, KY (US); Lindsay Boehme, Lexington, KY (US); James Landon, Lexington, KY (US)

(73) Assignee: PowerTech Water LLC, Lexington, KY (US)

(21) Appl. No.: 15/984,290

(22) Filed: May 18, 2018

Related U.S. Application Data
(60) Provisional application No. 62/508,351, filed on May 18, 2017.

(51) Int. Cl. C02F 1/469; C25B 15/02; H01M 8/04694; H01M 4/583

(52) U.S. Cl. CPC C02F 1/4691; C25B 15/02; C02F 2209/05; H01M 4/583; C02F 2201/46; H01M 8/04694

(57) ABSTRACT

Disclosed are activated carbon electrodes fabricated according to a “pore mouth diameter mixture profile” that is optimized for a given electrochemical application. In a given pore mouth diameter mixture profile, the pore mouth diameter and conductivity of activated carbon are tightly controlled and provide unexpected long-term charging/discharging (aka “cycling”) performance. A given “pore mouth diameter mixture profile” optimizes a mixture of pore mouth diameters for a given electrochemical application, such as energy storage, desalination, deionization, hydrolysis, and dialysis, inter alia.

### RELATED APPLICATIONS

This application claims the benefit under 37 CFR 1.78 of U.S. provisional patent application No. 62/508,351, filed May 18, 2017, entitled “Defined Carbon Porosity for Sustainable Capacitive Charging”.

### BACKGROUND OF THE INVENTION

### Field of the Invention

The field of the invention is capacitive, aka electrostatic, deionization devices and methods used to remove salt and other ions from solutions, and capacitive energy storage devices and methods.

### Definitions

“Adsorption” means attracting ions in an input stream to, and retaining those ions on an electrode surface.

“BET surface area” means surface area determined by the Brunauer-Emmett-Teller method, which is a physical adsorption-based method using nitrogen to determine the surface area of a material.

“Capacitive deionization” means removing ions from an input stream to a cell by adsorption, and passing the deionized stream to the cell output.

“Capacitive deionization cell” means a cell that uses electrostatic forces to adsorb ions from an input stream. In a “traditional” or “conventional” capacitive deionization cell, a positive voltage is applied to an anode electrode, and a negative voltage is applied to a cathode electrode, to cause adsorption of negative ions to the anode and positive ions to the cathode while the voltages are applied.

“Cell” means, for a deionization cell, a plurality of electrodes exposed to an input stream, with an outlet for the output stream/waste stream, a short-circuit switch or power supply attached to the electrodes, and a means of controlling the power supply. A cell can optionally include a means of controlling the input stream and the output stream/waste stream. “Cell” means, for an energy storage cell, a plurality of electrodes exposed to an electrolyte, a short-circuit switch or power supply attached to the electrodes, and a means of controlling the power supply. An energy storage cell is similar to a “deionization cell”, but is a closed system with no inlet or outlet streams.

“Charging potential” means a voltage applied to, or inherent in surface functional groups of, an electrode of a cell and which causes movement of ions in the input stream of a cell to an electrode.

“Conductivity” means the electrical conductivity of an input stream, output stream, or a waste stream. Conductivity is a surrogate measurement for the molarity of ions in an output stream or waste stream. Conductivity is directly proportional to molarity of ions in such streams.

“Co-ion” means, in a CDI cell, an anion that is attracted to a cathode when the cathode's potential is higher than its E_{PZC} and a cation that is attracted to an anode when the anode's potential is lower than its E_{PZC}.

“Counter-ion” means a negative ion that is attracted to a positively charged electrode and a positive ion that is attracted to a negatively charged cathode.

“CG” means a carbon that has a predominately mesoporous structure with a nominal surface area of ˜700 m²/g. CG was formulated by the inventors using the pore mouth diameter profile method disclosed herein and fabricated for the inventors by Calgon Corporation (Naperville, Ill.). CG is recited as Calgon® in the Tables.

“CV” means cyclic voltammogram.

“CX” means carbon xerogel. CX electrodes possess a mesoporous structure with a nominal surface area of ˜200 m²/g.

“Cycle” means a cycle of operation, adsorption followed by desorption, of a capacitive deionization cell or an energy storage cell.

“Deionization” means removing ions in an input stream by adsorption to an electrode surface and passing the deionized stream as output.

“Deionization cell” means a cell that removes ions from an input stream.

Deionization cells are of various types, e.g., traditional, and i-CDI.

“Desorption” means releasing adsorbed ions from an electrode and into a waste stream.

“Discharging potential” means a reduced or reversed polarity voltage applied to, or inherent in surface functional groups of, an electrode of a cell to cause desorption of ions from the electrode into a waste stream.

“Electrode” means a material, typically porous carbon, which is electrically conductive.

“i-CDI cell” means an “inverted” capacitive deionization cell that adsorbs ions when the electrodes are short-circuited, and desorbs ions when the electrodes are charged.

“E_{PZC}” or “potential of zero charge”, means the potential of an electrode at which there is a minimum in ion adsorption at the surface. EPZC can be intentionally shifted by surface modification of a carbon electrode, or inherently relocated as a result of oxidation of an electrode surface by extended cycling.

“Eₒ” is the potential vs. a reference electrode of a capacitive deionization cell when the electrodes are short-circuited (i.e., Eₒ is the potential during a short-circuit condition).

“Flow rate” means the flow rate, typically in L/hr, ml/min, etc., of an input, output, or waste stream.

“HE” means a high-efficiency mesoporous carbon of the invention. Electrodes made with HE carbon possess a predominately mesoporous structure with a nominal surface area of ˜380 m²/g. HE has a formulation of >98% mesoporous carbon with the balance being macroporous carbon. HE was formulated by the inventors using the pore mouth diameter profile method disclosed herein. BET assays did not detect any microporous carbon in HE.

“Input stream” means a liquid, typically water containing various ions, admitted to a cell.

“KN” means a microporous carbon marketed as Kynol® available from American Kynol, Inc (Pleasantville, N.Y.). Electrodes made with KN carbon possess a microporous structure with a nominal surface area of ˜1800 m²/g.

“N-” means negative surface charge, e.g., N—CX means a carbon xerogel electrode with net negatively charged surface groups.

“Output stream” means a liquid that has passed through an adsorbing deionization cell and contains a lower molarity of ions than in the input stream.

“P-” means positive surface charge, e.g., P—CX means a carbon xerogel electrode with net positively charged surface groups.

“Polarization window” means the span or range of potentials/voltages used to conduct deionization (adsorption) and regeneration (desorption) of a capacitive deionization cell.

“Polarity” means the polarity of a DC voltage, either positive or negative.

“Pore mouth diameter profile” means the volumetric ratio(s) among microporous, mesoporous, and macroporous carbon in an electrode fabricated according to the pore mouth diameter profile method disclosed herein.

“Pristine” in reference to electrodes means without surface modifications; for example, a Spectracarb electrode, as supplied by the manufacturer, is pristine.

“Purify” means to remove ions from an input stream. Purification includes water softening, i.e., the removal of calcium, magnesium, and certain other metal cations in hard water.

“Relocation” of an E_{PZC} is a change in potential (aka “location”) of the E_{PZC}, as shown in a cyclic voltammogram, of an electrode by accumulation of adsorption/desorption cycles.

To “shift” the “position” of an E_{PZC} means to alter the potential (aka “location”) of the E_{PZC} of an electrode by intentional chemical or electrochemical modification of the electrode surface.

“SC” means a microporous carbon marketed as Spectracarb™ available from Engineered Fibers Technology, LLC (Shelton, Conn.). Electrodes made with SC carbon possess a microporous structure with a nominal surface area of ˜1900 m²/g.

“SCE” means a saturated calomel electrode, a standard reference electrode commonly used as a reference electrode, e.g., in cyclic voltammetry

“Surface-charge enhanced surface” means an electrode surface that has been treated.

“Treat” means to modify an electrode surface to shift the E_{PZC} of the electrode.

“Untreated” means an electrode without an electrode surface modification disclosed herein, i.e., a pristine carbon electrode.

“Voltage” and “potential” are synonymous herein. Voltage is direct current (“DC”) unless otherwise specified.

“Waste stream” means a liquid that has passed through a desorbing deionization cell and contains a higher molarity of ions than in the input stream.

### Related Art

During capacitive charging processes, a constant current or voltage is used to charge electrode surfaces for the purposes of energy storage, desalination, or other useful capacitive techniques. Charging and subsequent discharging of electrodes is often carried out for thousands of cycles over a range of voltages and currents, depending on the intended application. Carbon electrodes made of activated carbon are often employed for these capacitive-based charging and discharging processes due to (i) their high specific surface area and resulting high capacitance, and (ii) opportunities to add functional groups to effect surface modifications that improve, inter alia, energy storage and desalination. Activated carbon is a form of carbon processed to have numerous small, low-volume pores that increase the surface area available for adsorption or chemical reactions. For a detailed description of traditional capacitive deionization (“CDI”), and inverse capacitive deionization (“i-CDP”), see U.S. application Ser. No. 14/757,209, by Gao, et al., entitled “Potential of Zero Charge-Based Capacitive Deionization”, which application is fully incorporated herein by reference. For a detailed description of energy storage using carbon electrode capacitors, see Chae, J. H.; Chen, G. Z. 1.9V aqueous carbon-carbon supercapacitors with unequal electrode capacitances. Electrochimica Acta. 2012, 86, 248-54, and Dai, Z.; Peng, C.; Chae, J. H.; Ng, K. C.; Chen, G. Z. Cell voltage versus electrode potential range in aqueous supercapacitors. Sci Rep. 2015, 5, 9854, which publications are fully incorporated herein by reference.

In broad terms, traditional CDI electrodes adsorb ions from an electrolyte when positive voltage is applied to one or more anodes, and negative voltage is applied to one or more cathodes; traditional CDI electrodes desorb ions when anode(s) and cathode(s) are shunted (form a short circuit) or a negative voltage is applied to one or more anodes, and positive voltage is applied to one or more cathodes. i-CDI relies upon permanent chemical modifications of electrode surfaces to shift the potential of zero charge (“E_{PZC}”) so that i-CDI electrodes adsorb ions from an electrolyte when anode(s) and cathode(s) are shunted; i-CDI electrodes desorb ions when positive voltage is applied to one or more anodes, and negative voltage is applied to one or more cathodes. i-CDI decreases the effect of multi-cycle oxidation of electrodes and can be used very advantageously with the pore mouth diameter mixture profile invention disclosed herein.

The size and volume of actual pores in activated carbon depend upon the shape, tortuosity (which is usually associated with changes in pore diameter), and length of a given pore. Based on micrographs of activated charcoal, and depending on the activation and/or synthesis procedures, some pores in activated carbon can be tubular channels, polygonal channels, spheroid chambers, surface slits, etc. Channels and chambers can be “dead end” or “through” (i.e., a channel or chamber with two surface appearances, aka “pore mouths”, with channel continuity between the two pore mouths). Pores in activated carbon are generalized as being tubular channels that have an average pore channel diameter (hereinafter “pore channel diameter”) and an average pore mouth diameter. Measuring actual pore channel diameter of billions of pores that rarely have a constant pore channel diameter in a mass of activated carbon is a herculean task, and not reported here. As a generalization, the pore channel diameter is assumed to be identical to the pore mouth diameter.

The inventors discovered that the diameter of a pore mouth, i.e., the opening of a pore to electrolyte, has a major, and in small pore mouth diameters, predominant, impact on the utilization of that pore for adsorption and on multi-cycle performance in desalination and energy storage. A larger pore mouth diameter (and therefore, pore mouth surface area) will provide significant contact area between the pore channel and the electrolyte. A small pore mouth diameter will have more limited contact area (i.e., “pore mouth surface area”). Pore mouth diameters are defined by IUPAC as microporous, mesoporous, and macroporous with pore mouth diameters of <2 nm, 2-50 nm, and >50 nm, respectively. The lifetime of an adsorption medium has a direct correlation to the pore mouth diameter present on the surface of the material. The concept and ramifications of “pore mouth roofing”, aka pore mouth closure, after repeated cycles of adsorption and desorption using an activated carbon electrode, is explained below. A pore mouth “roofed” or “closed” after repeated charge/discharge cycles so that the surface area of the pore channel no longer functions effectively in adsorption and desorption is said to be “collapsed”.

A factor that has been overlooked in the context of sustainable capacitive charging using activated carbon electrodes is that not only the proper pore mouth diameter, i.e. microporous, mesoporous, or macroporous, but also the “mixture profile” of pore mouth diameters for a given function (e.g., desalination, energy storage, etc.) is very important for the retention of long-term capacitive charging efficiency (i.e., over hundreds or thousands of charge/discharge cycles). At higher charging potentials (cell voltages>0.4 V), the propensity for the surface of a pore mouth of a carbon electrode to oxidize increases. In desalination applications, when charging is used in a conventional CDI cell to adsorb ions, both capacitive and Faradaic current can be present. The longer the charging cycle, the more Faradaic reactions can occur, such as carbon oxidation and pore mouth roofing. If shorter cycles are used, Faradaic current can be limited, thereby limiting oxidation and pore mouth roofing, and retaining adsorption capacity. Lower charging potentials can also be used to limit the degree of oxidation and pore mouth roofing. However, these methods can only be used to limit the extent of pore mouth roofing and do not solve the issue; such methods (shorter cycles, and lower charging potentials) also lower the capacity of a CDI cell. Similar issues can be seen over long-term cycling of carbon electrodes in supercapacitors. A bibliography of journal articles that discuss decreased performance of activated carbon electrodes, and that fail to identify the prevention or remediation of pore roofing and pore volume reduction, is appended. Oxidation of the anode due to electrochemical oxidation during cycling has been identified as a major problem in CDI. In Cohen, I.; Avraham, E.; Bouhadana, Y.; Soffer, A.; Aurbach, D. Long term stability of capacitive de-ionization processes for water desalination: The challenge of positive electrodes corrosion Electrochim. Acta 2013, 106, 91-100, chemically oxidized electrodes were used in an attempt to protect the anode from further oxidation, however decreased desalination performance with CDI cell cycling persisted and a means of completely eliminating its occurrence was not achieved.

In Bouhadana, Y.; Avraham, E.; Noked, M.; Ben-Tzion, M.; Soffer, A.; Aurbach, D. Capacitive deionization of NaCl solutions at non-steady-state conditions: inversion functionality of the carbon electrodes J. Phys. Chem. C 2011, 115(33), 16567-16573, the electrochemical oxidation of the positive electrode (the anode) was studied and oxidized surface groups were identified. In Gao, X.; Omosebi, A.; Landon, J.; Liu, K. Dependence of the capacitive deionization performance on potential of zero charge shifting of carbon xerogel electrodes during long-term operation J. Electrochem. Soc. 2014, 161(12), E159-E166, deionization performance was shown to degrade with prolonged cycling of a CDI cell with CX electrodes. Analysis of the electrodes before and after cycling showed a positive shift in the E_{pzc} location of the anode, indicative of oxidation, but no solution for this problem was given. In Gao, X.; Omosebi, A.; Landon, J.; Liu, K. Surface charge enhanced carbon electrodes for stable and efficient capacitive deionization using inverted adsorption-desorption behavior Energy Environ. Sci. 2015, 8(3), 897-909, an anode with net negative surface charges was used and the cell was operated in i-CDI mode to improve performance stability, but the locus of the oxidation and a pore mouth-based solution were not identified. Performance was maintained for 600 cycles with carbon xerogel electrodes. In Gao, X.; Omosebi, A.; Landon, J.; Liu, K. Voltage-Based Stabilization of Microporous Carbon Electrodes for Inverted Capacitive Deionization, J. Phys. Chem. C, 2018, 122(2), 1158-1168, lower charging voltages were applied to limit anode oxidation, but the location of the oxidation and a pore mouth-based preventative solution were not identified. In general terms, the prior art describes the decreased performance of activated carbon electrodes used in energy storage and in desalination after repeated cycles of adsorption and desorption, but does not associate decreased performance with pore mouth roofing or suggest a means of avoiding decreased performance.

To combat pore collapse, researchers in supercapacitors have practiced a concept called mass balancing in which the anode is a larger mass than the cathode to improve charging stability. In Chae, J. H.; Chen, G. Z. 1.9V aqueous carbon-carbon supercapacitors with unequal electrode capacitances. Electrochimica Acta. 2012, 86, 248-54 and Dai, Z.; Peng, C.; Chae, J. H.; Ng, K. C.; Chen, G. Z. Cell voltage versus electrode potential range in aqueous supercapacitors. Sci Rep. 2015, 5, 9854, employing unequal electrode capacitances (using an anode with a larger mass) extended the working voltage window, improving the energy capacity and stability with repeated cycling. However, mass balancing did not address any root cause of performance degradation of carbon electrodes.

This oxidation process can have many unintended consequences, in addition to loss of pore space through “roofing” of the pore mouth (shown in FIG. 4B), such as accumulation of oxidative products on the pore walls, decreased pore volume, increased resistivity, and ultimately device performance loss due to loss of capacitance. In view of the performance deterioration and short life of prior art electrodes in energy storage, desalination, and other electrochemical systems, there is an unmet need for better performing, and longer lived, carbon electrodes.

### SUMMARY OF THE INVENTION

Disclosed herein are carbon electrodes for capacitive-based desalination, energy storage, and other electrochemical systems fabricated using a “pore mouth diameter mixture profile” method that determines a formulation of a carbon electrode optimized for a given electrochemical application. In a given pore mouth diameter mixture profile, the pore mouth diameter and conductivity of activated carbon are tightly controlled and provide unexpected long-term charging/discharging (aka “cycling”) performance. Long-term cycling performance is directly proportional to electrode surface area: electrode performance requires that anolytes and catholytes be rapidly adsorbed on, and desorbed from, maximum electrode surface area for a given electrode mass over time. Tight control, or “tuning”, of pore mouth diameter and conductivity for a given electrochemical application significantly avoids or delays pore mouth roofing, thereby preventing pore mouth collapse, and preserving pore volume and surface area of carbon electrodes. A given “pore mouth diameter mixture profile” optimizes a mixture of pore mouth diameters for a given electrochemical application, such as energy storage, desalination, deionization, hydrolysis, and dialysis, inter alia.

### BRIEF DESCRIPTION OF THE DRAWINGS

FIG. 1. Charge passed with commercially available microporous (SC and KN), a predominately mesoporous (CG), and mesoporous (CX, aka generic CX) carbon electrodes in a flow-through capacitive deionization cell. The order of the carbon types in the legend is also the order of the starting traces.

FIG. 2. Charge passed with KN and CG carbon electrodes in a flow-by capacitive deionization cell. The order of the carbon types in the legend is also the order of the starting traces.

FIGS. 3A and 3B. Schematic for two pairs of electrodes used for desalination for flow-through (FIG. 3A) and flow-by (FIG. 3B) cell architectures. The components present in FIG. 3A are the same for FIG. 3B, only the flow path changes. In flow-through the stream flows perpendicular to the electrodes, while inflow-by the stream flows parallel. 1—anode (carbon), 2—current collector, 3—separator, 4—cathode (carbon), 5—power supply, arrow—direction of water flow.

FIGS. 4A and 4B. FIG. 4A shows a shaded band that was the target zone for charge passed per gram of the inventors' high-efficiency carbon electrode for inverted capacitive deionization (i-CDI) cells with 12 pairs of electrodes in 18.5 L of 4.3 mM NaCl using a charging voltage of 0.8 V (for desorption) and a discharging voltage of 0 V (for adsorption). Total cycle time was 3 h. Pristine Spectracarb (SC), Kynol (KN), Calgon (CG) or carbon xerogel (CX) was used for the cathodes and nitric acid oxidized SC, KN, CG, or CX was used to make the anodes used in the experiments. FIG. 4B shows the actual results (black ++++ data points) using the inventors' high-efficiency carbon electrode, which achieved the target charge passed per gram of electrode for i-CDI cells shown in FIG. 4A. The order of the carbon types in the legend is also the order of the starting CV traces.

FIGS. 5A, 5B, and 5C. FIG. 5A shows representative pore sizes of carbon electrode materials. FIG. 5B shows a schematic view of microporous carbon pores (pristine, and roofed until pore mouth collapse). FIG. 5C shows a schematic view of mesoporous carbon pores (pristine, and partially roofed without pore mouth collapse).

FIGS. 6A, 6B, 6C, 6D, and 6E. FIG. 6A through 6E show cyclic voltammograms (CV) at a scan rate of 0.5 mV/s in 4.3 mM NaCl with carbon as the cathode, Pt coated Ti as the anode, and a standard calomel electrode (SCE) as the reference. Accelerated oxidation studies were performed at 2.0 V for 6 hours. Pristine carbon is compared to electrochemically oxidized carbon at 3 and 6-hour time steps for a given carbon. FIG. 6A shows CVs for microporous SC. After 3 hours of electrochemical oxidation the E_{PZC} has shifted to the right, indicative of the formation of oxygen surface groups on the carbon electrode. After 6 hours the E_{pzc} is no longer present and there is a noticeable decrease in current, signifying pore collapse. FIG. 6B shows CVs for microporous KN. The same trend is observed as for SC in FIG. 6A. FIG. 6C shows CVs for CG, a primarily mesoporous carbon. After 3 and 6 hours of electrochemical oxidation the E_{PZC} has shifted to the right, indicative of the formation of oxidized surface groups on the carbon electrode, but the current is maintained due to non-collapsed pores. FIG. 6D shows CVs for mesoporous CX and FIG. 6E shows CVs for mesoporous HE, both of which follow the same trend observed for CG in FIG. 6C: current is maintained due to non-collapsed pores.

FIGS. 7A and 7B. Schematic depicting the differences between a supercapacitor (FIG. 7A) and a capacitive deionization (CDI) cell (FIG. 7B). 1—cathode (carbon), 2—current collector, 3—electrolyte, 4—separator, 5—anode (carbon), and 6—power supply. A supercapacitor cell is a closed cell; a CDI cell has inlet and outlet streams.

FIGS. 8A and 8B. A schematic of two electrodes used to demonstrate the mass balancing technique. FIG. 8A shows a conventional electrode set-up where the cathode and anode are the same size. FIG. 8B shows a mass balanced electrode set-up where the anode is larger than the cathode to lower the distributed voltage to the anode. 1—cathode (carbon), 2—anode (carbon), and 3—power supply.

FIG. 9. A schematic of an EDR cell with one pair of electrodes. Water flows through the cell producing desalinated streams, shown as product, and concentrated waste streams, shown as concentrate. 1—current collector, 2—cathode (carbon), 3—cation membrane, 4—anion membrane, 5—anode (carbon), 6—power supply, and arrows—direction of water flow.

### DETAILED DESCIPTION OF THE PREFERRED EMBODIMENTS

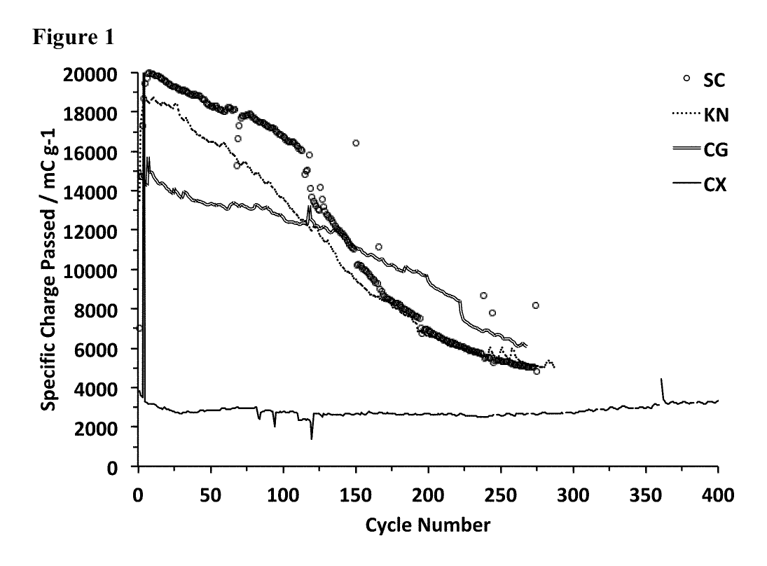

The inventors are the first to disclose a carbon electrode that addresses the effects of pore mouth roofing and pore volume decrease from oxidative reactions in electrochemical systems. Pore mouth roofing, and pore volume decrease, result in major performance deterioration and short life of prior art electrodes in energy storage and desalination applications. Shown in FIG. 1 is an example of the charge passed per gram of carbon for microporous (Spectracarb™ (“SC”) and Kynol® (“KN”)) carbon, a predominately mesoporous carbon formulated according to the pore mouth diameter profile method (“CG”), and mesoporous (carbon xerogel “CX”) carbon electrodes over the course of >200 cycles with each cycle lasting 3 hours (>300 total hours of charging, >300 total hours of discharging). The inventors observed that charge passed for the microporous carbon electrodes initially plateaus before a sharp drop in performance after ˜100 charge/discharge cycles (“cycles”). Unlike the microporous carbon, the mesoporous carbon shows continued, generally uniform performance over hundreds of cycles. Ideally, a carbon material would have sustained higher charging capacities for >100 cycles.

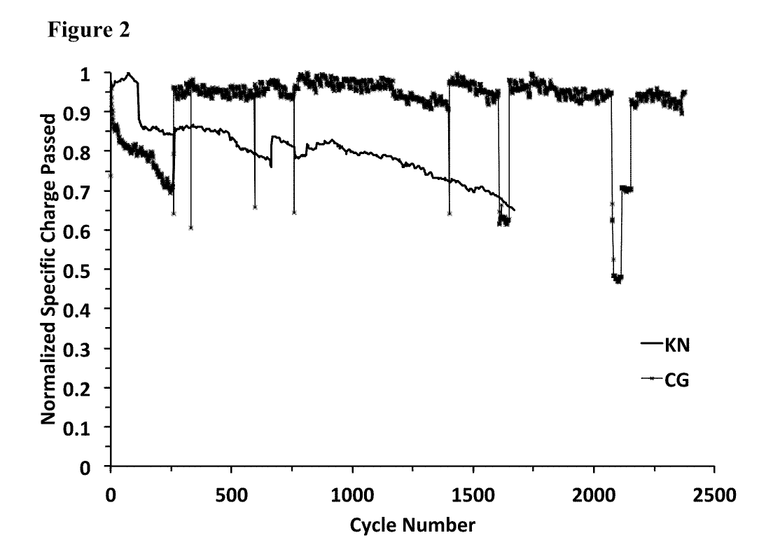

The various embodiments of the invention are tailored mixtures of both microporous and mesoporous carbon. Mixtures of microporous and mesoporous carbon are abbreviated based on percentage content, in a “microporous volume percentage/mesoporous volume percentage” format, e.g., 11% microporous and 89% mesoporous carbon is called an “11/89” mixture. The CG carbon used in the experiments reported herein is an 11/89 formulation developed using the pore mouth diameter profile method disclosed herein, and custom fabricated for the inventors. An 11/89 mixture has improved performance over the microporous carbon with a slower decay in performance, but it is not as stable as the generic mesoporous carbon. FIG. 2 shows a similar trend for microporous vs. mesoporous carbons for a flow-by cell design.

CX predominately mesoporous carbon contains an average pore mouth diameter of 20-40 nm and specific surface areas between 100-300 m²/g. In contrast to mesoporous carbon electrodes, commercially available microporous carbon electrodes have an average pore mouth diameter of <2 nm with specific areas between 1500-2000 m²/g. CG microporous/mesoporous carbon contains an average pore mouth diameter of 0.5-10 nm and specific surface areas between 500-1000 m²/g. Generic mesoporous carbon electrodes (average pore mouth diameter of 10-45 nm and specific surface areas between 100-300 m²/g) are called herein, “generic CX”.

HE predominately mesoporous carbon contains an average pore mouth diameter of 2.5 to 4 nm, containing >98% mesoporous carbon with the balance being macroporous carbon. HE was formulated by the inventors using the pore mouth diameter profile method disclosed herein.

The inventors' research focused on trying to develop a carbon material with the continued, generally uniform capacitive performance of generic CX but with much higher adsorption efficiency. The inventors developed a much higher adsorption efficiency carbon electrode material that has smaller mesopore (3-5 nm) pore mouth diameter and specific surface areas between 300-500 m²/g. The inventors' “high-efficiency” (HE) mesoporous carbon (1) has much higher charge storage per gram of carbon compared to commercially available carbon electrodes, (2) has sustained performance for >500 hours of cycling, and (3) avoids the sharp drop in performance after 100 cycles characteristic of microporous carbon.

Multiple cell designs have been shown for capacitive deionization (CDI) in the past, and each cell design can have an impact on oxidation routes of the carbon anode. The two most common designs are flow-through and flow-by. In Cohen, I.; Avraham, E.; Bouhadana, Y.; Soffer, A.; Aurbach, D. Long term stability of capacitive de-ionization processes for water desalination: The challenge of positive electrodes corrosion Electrochim. Acta 2013, 106, 91-100 and in Suss, M. E.; Baumann, T. F.; Bourcier, W. L.; Spadaccini, C. M.; Rose, K. A.; Santiago, J. G.; Stadermann, M. Capacitive desalination with flow-through electrodes, Energy Environ. Sci. 2015, 5, 9511-9519, a flow-through architecture is used for desalination. The use of a flow-through cell design has the benefits of increased adsorption kinetics, but the pH changes and reaction products from the carbon cathode can directly impact the carbon anode and increase the rate of pore collapse of the anode (points 2 and 3 above). Flow-by cell designs will still be impacted by these processes, but to a lesser extent. Likewise, both cell designs will experience electrochemical carbon oxidation at the anode, regardless of flow regime, making the use of a high-efficiency carbon electrode preferable to delay or eliminate the effects of pore collapse on the separation/ion storage process.

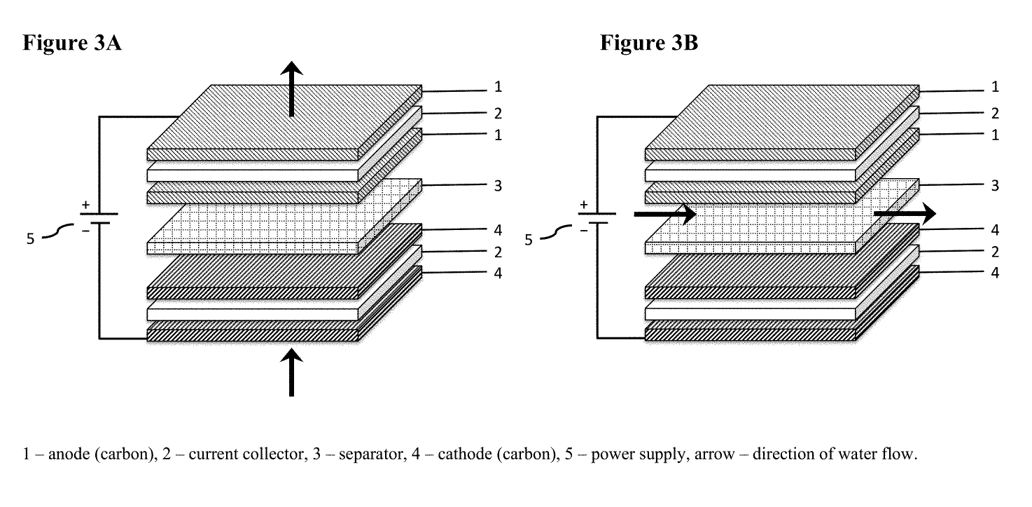

Flow-through cells have the electrolyte flow directly through (perpendicular to) the carbon electrodes during separation and regeneration while inflow-by cells, the electrolyte will flow parallel to the electrode surface. Separation performance and charge stability for each carbon, reported below, was compared using flow-through inverted capacitive deionization (i-CDI) cells with 12 pairs of electrodes in 18.5 L of 4.3 mM NaCl using a charging voltage of 0.8 V and a discharging voltage of 0 V, with a total cycle time of 3 h. Flow-by i-CDI cells with 14 pairs of electrodes in 18.5 L of synthetic tap water using a charging voltage of 0.4 V and a discharging voltage of −0.2 V, with a total cycle time of 20 min, 30 min, or 1 h, reported below, were used to compare the KN microporous and CG (primarily mesoporous) carbons. Schematics of both cell architectures are shown in FIG. 3.

It will take longer for pore mouth collapse to occur with a flow-by CDI design. Pore collapse, which leads to significant decreases in carbon pore volume and surface area, is exacerbated due to oxidation routes at the carbon anode. This oxidation is a function of (1) electrochemical carbon reactions with water, (2) increases in the pH from reactions at the cathode that leads to increased driving force for oxidation reactions at the cathode, and (3) reaction products from the cathode such as hydrogen peroxide that can oxidize the carbon anode.

Mesoporous electrodes for desalination typically have a pore mouth diameter of 2-50 nm, but the inventors have identified ˜5 nm as optimal. Oxidative roofing is a greater problem in desalination cells compared to energy storage cells because the electrolyte salt concentration is lower, and the system is open.

While supercapacitors and CDI cells have similar components, such as carbon anodes, carbon cathodes, an electrolyte, and an external voltage source used to control adsorption/desorption of ions on the carbon surface through the electrical double layer, some notable discrepancies can be found. Supercapacitors adsorb and desorb ions from a concentrated electrolyte (such as 1 M sodium sulfate) inside a closed or sealed cell. The electrolyte is tailored for maximizing the charge storage of the cell and no outside compounds impact the carbon electrodes. In a CDI cell, the carbon material is in contact with an electrolyte that is constantly changing as this system is used to separate ions from an incoming feed stream, not for charge storage. The carbon electrodes used in CDI cells come into contact with dissolved oxygen and a lower concentration of salt species.

The differences between supercapacitors and CDI leads to a notable difference in the degradation of the carbon anodes. The anode will oxidize due to electrochemical reactions with water in both systems resulting in pore mouth roofing and pore mouth collapse. However, pore mouth collapse is intensified for carbon anodes in CDI cells due to lower electrolyte concentrations (higher likelihood of Faradaic reactions such as carbon oxidation), and the presence of dissolved oxygen that reacts at the carbon cathode and produces perturbations in pH and hydrogen peroxide that can increase the oxidation rate at the anode. Although pore mouth collapse can take place in both systems, the effect will be more profound earlier in the device lifetime for a CDI cell. In embodiments of the invention, a more stable carbon anode (high efficiency carbon electrode) can be used either in conjunction with mass balancing or as a standalone technique. A more stable, oxidation resistant anode can substantially increase the usable lifetime of both a supercapacitor and a CDI cell by limiting oxidation reactions that lead to pore mouth collapse. Pore mouth collapse decreases the surface area for charge storage or ion separation.

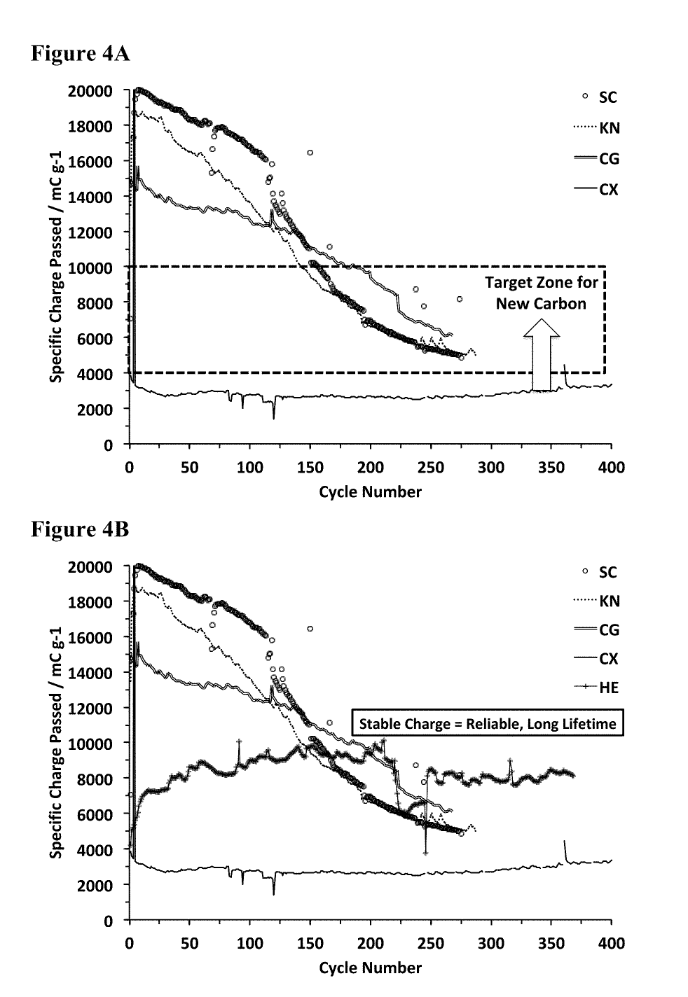

The target properties of the inventors' high-efficiency mesoporous carbon material (shaded band in FIG. 4A were: pore mouth diameter 3-10 nm; thickness<600 μm; conductivity>5 S/cm; surface area>400 m²/g; and pore volume>1 cm³/g. One embodiment of the high-efficiency carbon of the invention has an average pore mouth diameter of 3.4 nm, a thickness of 580 μm, a conductivity of 49 S/cm, a specific surface area of 378 m²/g, and a pore volume of 0.235 cm³/g, and achieves the desired increase in performance (FIG. 4B). Table 1 lists the pertinent material properties for all carbons discussed herein.

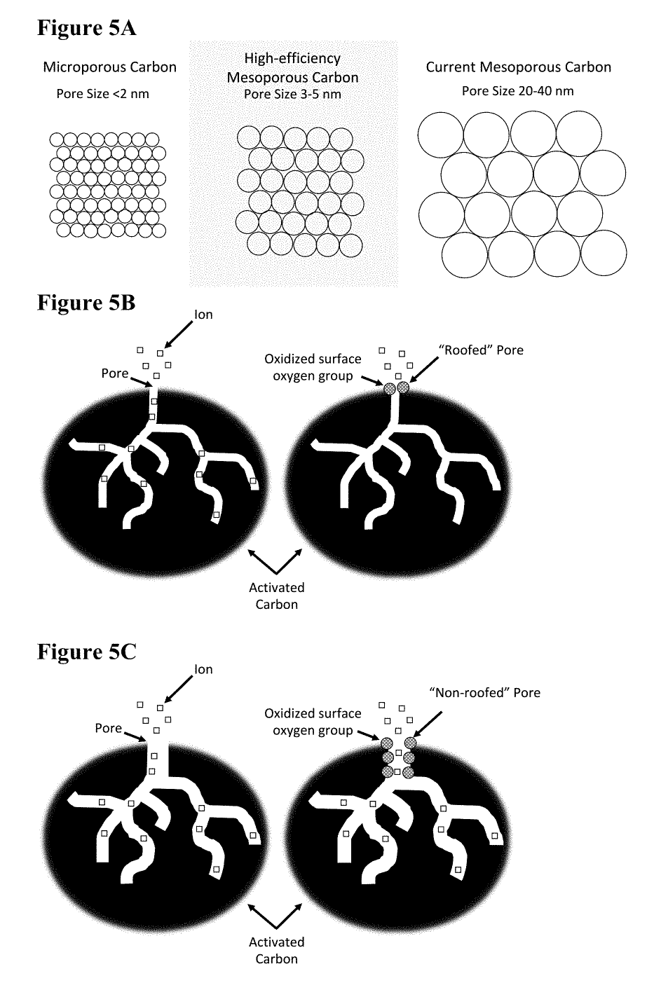

When a voltage is applied across the carbon electrodes in a cell, the anode is at a positive potential (facilitating oxidation) and the cathode at a negative potential (facilitating reduction). This causes the anode to oxidize and oxygen surface groups to form over time. The smaller the pore diameter (micropore), the more likely it will get blocked by these oxygen surface groups (in a process called, “roofing”) and prevent ion adsorption within the pore volume of the carbon electrode (FIG. 5B). With a larger pore mouth diameter (mesopores), ions can enter the pore volume regardless of oxygen groups present at the surface (FIG. 5C), providing sustained stable salt adsorption performance; however, mesoporous carbon has significantly less total surface area compared to microporous carbon. The inventors' experimental data show that there is linear decrease in charge efficiency until an average pore diameter of 3-5 nm, below which diameter charge efficiency drastically and nonlinearly decreases. For CG, the micropores would collapse first, leaving only the remaining mesopores available for ion adsorption. This phenomenon is reflected by the gradual decay in specific charge passed shown in FIG. 1.

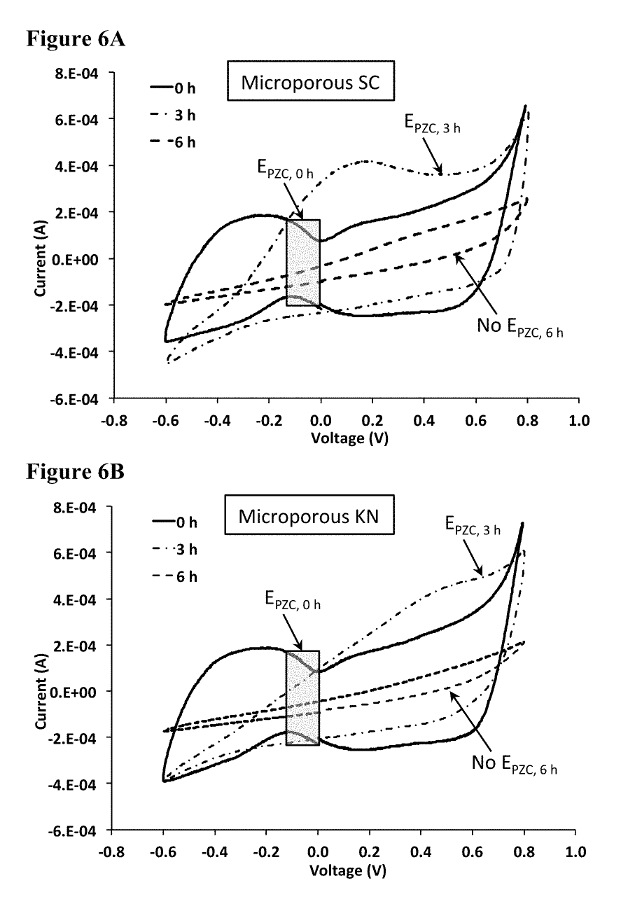

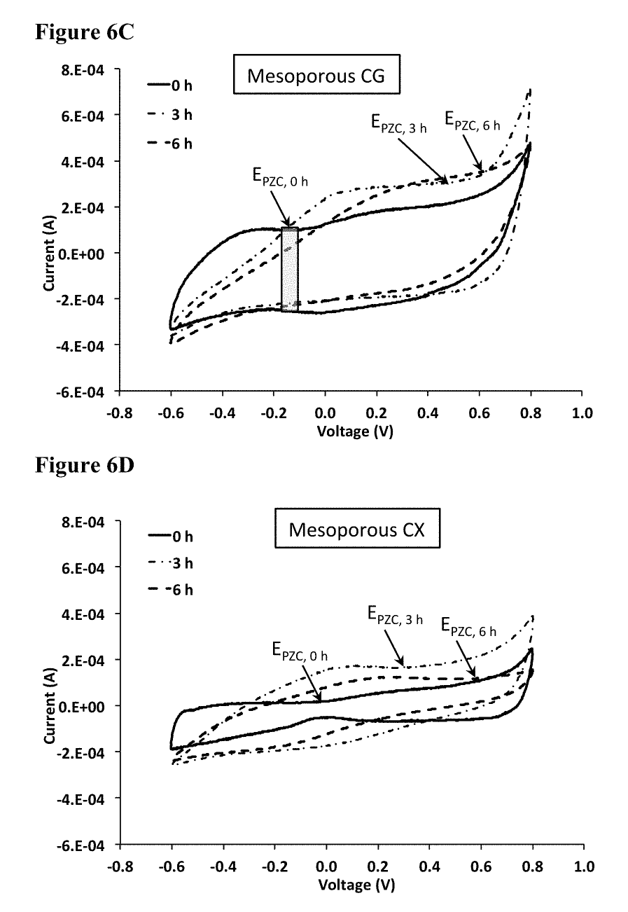

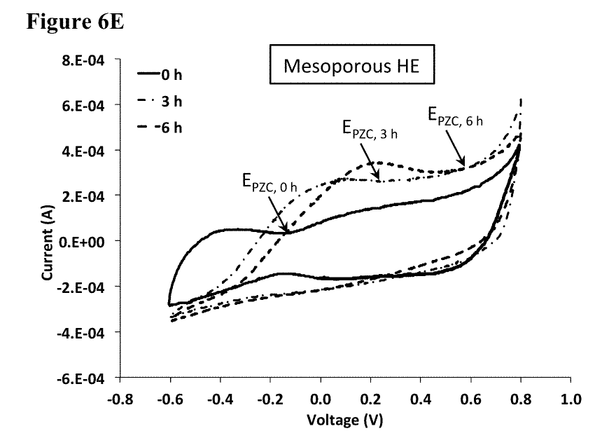

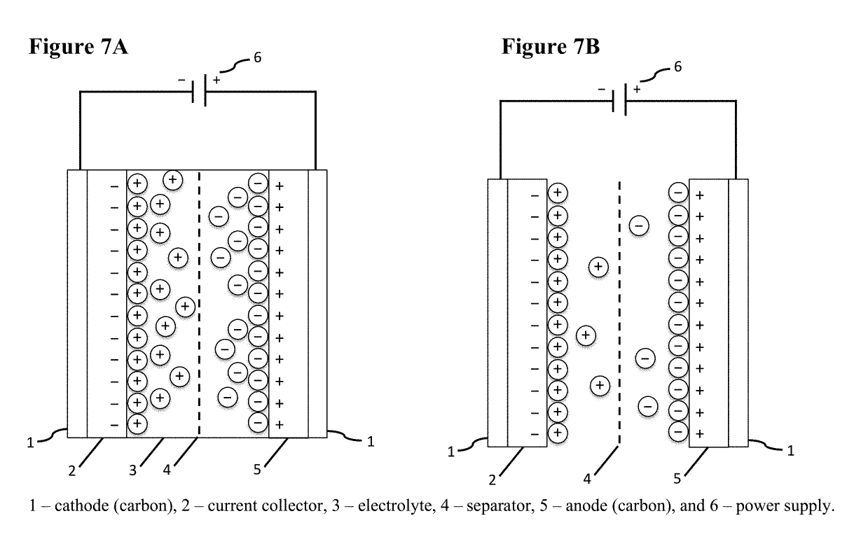

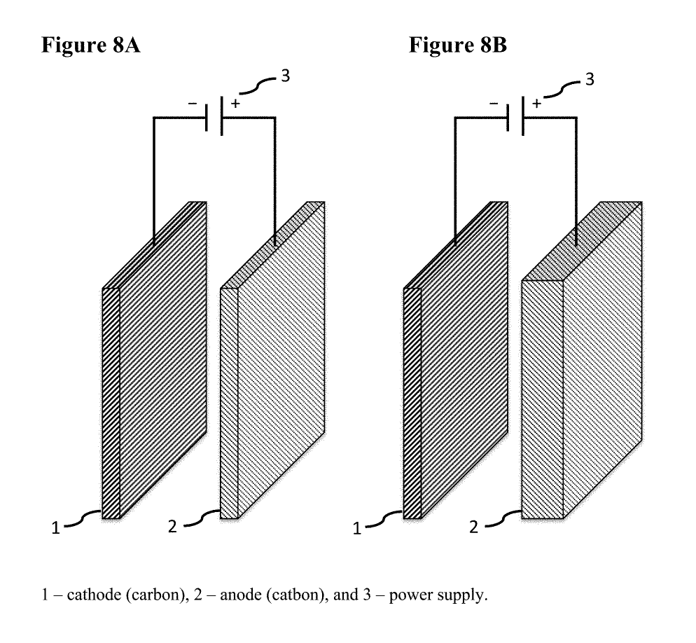

A simple comparison of carbon electrode pore diameters, shown in FIG. 5A, does not suggest the unexpected properties of the inventors' high adsorption-efficiency activated carbon mixture. Accelerated oxidation studies and loss of surface area from capacitance measurements support the effect of pore “collapse and roofing” observed with microporous carbon. Pore roofing is when the pore appearance, or pore mouth, becomes blocked by surface oxide groups due to reaction between the carbon electrode and the aqueous electrolyte, preventing ion adsorption into the pore volume. Once the pore mouth is completely (in physical, stearic, or ionic terms) blocked or filled, the pore is said to have experienced “pore collapse”. FIGS. 5B and 5C show pore roofing and ultimate collapse for pores with varying pore diameters. To demonstrate pore roofing, using commercial and high efficiency synthesized carbon electrodes of the invention, carbon was electrochemically oxidized at 2.0 V in 1 hour increments for a total of 6 hours. As shown in FIGS. 6A to 6E, cyclic voltammograms (CV) were performed before and after each oxidation step (an “oxidation step” herein is 3 hours of cycling) to determine whether there was a change in current, overall shape of the CV curve, and potential of zero charge (potential at which there is no net charge on an electrode, or E_{pzc}). Representative CVs for each carbon are shown in FIGS. 6A to 6E. Microporous carbons (SC and KN) were significantly oxidized after 3 hours and completely collapsed after 6 hours (FIGS. 6A and 6B). The E_{pzc}s shifted more anodic, indicative of oxidation, and the area under the curve dramatically reduced over time. Whereas CG (FIG. 6C), and mesoporous carbons, CX and HE (FIGS. 6D and 6E), showed oxidation after 6 hours but maintained current. The E_{pzc}s shifted more anodic, but the area under the curves was preserved. The electrochemical surface areas were calculated for the pristine and electrochemically oxidized carbons after 6 hours at 2.0 V (Table 2). THE percent loss in surface area from lowest to highest is as follows: HE, CX<CG<SC<KN (stated more generally, HE or mesoporous<CG<microporous). This emphasizes that mesoporous carbons can handle a large applied voltage while maintaining charge and avoiding the effect of pores collapsing and roofing, leading to a reliable, long lifetime.

The surface of an HE carbon electrode can be modified by adding functional groups to improve device performance, e.g., to shift the Epzc of electrodes for use in an i-CDI system. Although shifting the Epzc does improve ionic separation, based on data collected to date, shifting the Epzc does slow down pore mouth roofing. The functional groups for desalination are selected to match the surface charge for the intended application, meaning anodes with negative surface charge (positive E_{PZC}) and cathodes with positive surface charge (negative E_{PZC}) for i-CDI and the reverse for CDI.

Pore mouth diameter profile and pore volume (and associated carbon electrode density) are optimized for a given electrochemical application using the pore mouth diameter profile method disclosed herein. High pore volume in cm³/g will yield high specific surface area in m²/g, but the mass of carbon per volume of device will be low, which means less total carbon available. One criterion in selecting a pore mouth diameter profile in fabricating electrodes for a given energy storage, desalination, deionization, hydrolysis, dialysis, or other electrochemical application is to avoid (i) too small a pore mouth diameter, and (ii) too high a percentage of microporous carbon. A second criterion is selecting the largest pore mouth diameter in the profile. A third criterion is selecting the volume percentage of each type of carbon, which is done experimentally for a given electrolyte. For desalination, the average pore mouth diameter should be 3-10 nm (small mesopores) to prevent pore collapse in aqueous electrolytes. For desalination, pore volumes>0.1 cm³/g will be needed to have substantial adsorption space. For a given application, exact values related to carbon density, average pore mouth diameter, and pore mouth diameter profile (i.e., the volumetric ratios among microporous, mesoporous, and macroporous carbon) are determined experimentally using CVs.

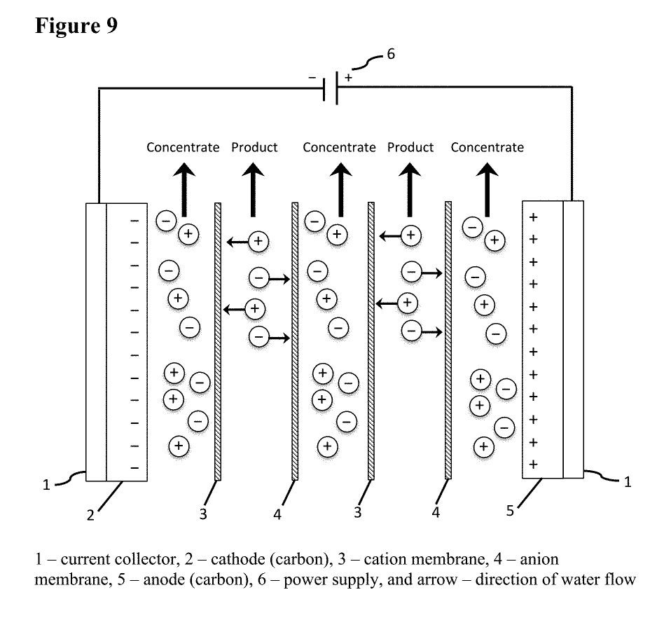

Electrodialysis reversal (EDR) is a water treatment process that uses an electric field, carbon or metallic electrodes, and ion exchange membranes to selectively remove ions from water streams. A schematic of an EDR cell is shown in FIG. 9. Selective movement of ions is accomplished through the incorporation of cation and anion exchange membranes in the cell. In EDR, the electric field or voltage is periodically reversed to help prevent fouling of the ion exchange membranes. When carbon electrodes are used in an EDR cell stack, pore mouth roofing can occur due to similar mechanisms described above for CDI and supercapacitor systems. However, the voltages are larger and the pore mouth roofing can occur more quickly due to the combination of dilute electrolyte and higher voltages. E_{pzc}n-shifting may be made with the HE carbon of the invention, thereby combining the advantages of E_{pzc} shifting and decreased pore mouth roofing.

Experimental results, such as those presented above, provide the following guidelines for working of the invention:

For desalination CDI, i-CDI, EDR, or other electrochemical systems, carbon electrodes of the invention have an average pore mouth diameter in the range of 2.5 to 10 nm achieved with a pore mouth diameter profile either (i) from 0% to 30% microporous (<2.5 nm) activated carbon and from 70% to 100% mesoporous (>2.5 nm and <50 nm) activated carbon or (ii) from 80% to 100% mesoporous activated carbon and from 0% to 20% macroporous (>50 nm) activated carbon.

For desalination, CDI, i-CDI, EDR, or other electrochemical systems, carbon electrodes of the invention have an average pore mouth diameter preferably in the range of 2.5 to 8 nm achieved with a pore mouth diameter profile either (i) from 0% to 30% microporous (<2.5 nm) activated carbon and from 70% to 100% mesoporous (>2.5 nm and <50 nm) activated carbon or (ii) from 80% to 100% mesoporous activated carbon and from 0% to 20% macroporous (>50 nm) activated carbon.

For desalination, CDI, i-CDI, EDR, or other electrochemical systems, carbon electrodes of the invention have an average pore mouth diameter more preferably in the range of 2.5 to 5 nm achieved with a pore mouth diameter profile either (i) from 0% to 30% microporous (<2.5 nm) activated carbon and from 70% to 100% mesoporous (>2.5 nm and <50 nm) activated carbon or (ii) from 80% to 100% mesoporous activated carbon and from 0% to 20% macroporous (>50 nm) activated carbon.

For desalination, CDI, i-CDI, EDR, or other electrochemical systems, carbon electrodes of the invention have an average pore mouth diameter more preferably in the range of 2.5 to 4 nm achieved with a pore mouth diameter profile either (i) from 0% to 30% microporous (<2.5 nm) activated carbon and from 70% to 100% mesoporous (>2.5 nm and <50 nm) activated carbon or (ii) from 80% to 100% mesoporous activated carbon and from 0% to 20% macroporous (>50 nm) activated carbon.

“Other electrochemical systems” comprise energy storage, batteries, supercapacitors, deionization, hydrolysis, dialysis, and fuel cells.

The preferred method of selecting a pore mouth diameter profile (aka, the “pore mouth diameter profile method”) in fabricating electrodes of the invention for an electrochemical application is by:

excluding activated carbon with a pore mouth diameter of less than 2.5 nm,

excluding volume percentages of microporous carbon of more than 30%, and

maximizing the volume percentage of mesoporous activated carbon without a drop in the specific charge passed/mCg⁻¹ of more than 30% based on at least 100 cycles of charging/discharging in a selected electrochemical system.

TABLE 1
Carbon Properties

| | | | Resis- | | Pore |
|---|---|---|---|---|---|
| | Surface | Thick- | tivity^{b} | Conduc- | Mouth |
| | Area^{a} | ness | (Ohm · | tivity | Diameter |
| Material | (m²/g) | (mm) | cm) | (S/cm) | (nm) |
| Spectracarb (SC) | 1951 | 0.54 | 0.69 | 1.45 | <1 |
| Kynol ® (KM) | 1822 | 0.46 | 0.45 | 2.24 | 2.2 |
| Calgon ® (CG) | 718 | 0.66 | 0.47 | 2.14 | 0.5-10 |
| Carbon Xerogel | 250 | 0.32 | 0.013 | 78.09 | 10-45 |
| (CX) | | | | | (25 ave.) |
| High-Efficiency | 378 | 0.58 | 0.020 | 49.32 | 3.4 |
| (HE) | | | | | |

^{a}measured by Brunauer-Emmett-Teller (BET) theory
^{b}average of three measurements taken with a four point probe

TABLE 2
Percent surface area lost due to electrochemical oxidation for
6 hours at 2.0 V in 4.3 mM NaCl as calculated from specific
capacitance measurements. Cyclic voltammograms were run
in 1 M NaSO₄ at scan rates of 1, 5, 10, 20, 40, 60, 80, and 100
mV/s. The total current at 100 mV was plotted vs. the scan
rate to obtain the geometric capacitance. The specific capacitance
was obtained by dividing the geometric capacitance by the mass
of carbon and the electrochemical surface area was then calculated
from Eq. 1.

| | Surface Area | Surface Area | | |
|---|---|---|---|---|
| | from BET | from Capacitance (m²/g) | | |
| Material | (m²/g) | Pristine | Cycled 6 h @ 2.0 V | % Loss |
| Spectracarb | 1951 | 3712 | 1195 | 68 |
| (SC) | | | | |
| Kynol ® (KN) | 1822 | 4758 | 1179 | 75 |
| Calgon ® (CG) | 718 | 3419 | 3074 | 10 |
| Carbon Xerogel | 250 | 434 | 2723 | N/A |
| (CX) | | | | |
| High-Efficiency | 378 | 970 | 1812 | N/A |
| (HE) | | | | |

Eq. 1:
Electrochemical surface area (m²g⁻¹) = Specific capacitance(Fg^{-g}) ×
$\frac{{cm}^{2}}{{10}^{- 5} F} \times \frac{1 {m}^{2}}{100 {cm}^{2}}$

### Example 1

18.5 L of 4.3 mM NaCl solution was treated by a small PowerTech Water device (PowerTech LLC, Lexington, Ky.) where the anode had been oxidized using nitric acid and the cathode was a pristine carbon electrode. Between 10-15 grams of carbon was used in a flow-through “inverted” capacitive deionization cell (aka i-CDI, disclosed by the inventors in USPUB 20160167984) and operated using a cell charging potential of 0.8 V and a discharge potential of 0 V. The NaCl solution was sent directly through the capacitive deionization cell at 20 ml/min.

We claim:

1. A carbon electrode used in an electrochemical system, wherein an average pore mouth diameter of the carbon is in the range of 2.5 to 10 nm achieved with a pore mouth diameter profile from 0% to 30% microporous activated carbon and from 70% to 100% mesoporous activated carbon.

2. A carbon electrode used in an electrochemical system, wherein an average pore mouth diameter of the carbon is in the range of 2.5 to 10 nm achieved with a pore mouth diameter profile from 80% to 100% mesoporous activated carbon and from 0% to 20% macroporous activated carbon.

3. The electrode of claim 1, wherein the electrochemical system is selected from the group consisting of energy storage, batteries, supercapacitors, CDI desalination, i-CDI desalination, deionization, hydrolysis, dialysis, electrodialysis reversal, and fuel cells.

4. The electrode of claim 2, wherein the electrochemical system is selected from the group consisting of energy storage, batteries, supercapacitors, CDI desalination, i-CDI desalination, deionization, hydrolysis, dialysis, electrodialysis reversal, and fuel cells.

5. The electrode of claim 1, wherein the electrochemical system is selected from the group consisting of energy storage, batteries, supercapacitors, CDI desalination, i-CDI desalination, deionization, hydrolysis, dialysis, electrodialysis reversal, and fuel cells, and wherein the carbon has an average pore mouth diameter in the range of 3 to 5 nm achieved with a pore mouth diameter profile from 0% to 30% microporous activated carbon and from 70% to 100% mesoporous activated carbon.

6. The electrode of claim 2, wherein the electrochemical system is selected from the group consisting of energy storage, batteries, supercapacitors, CDI desalination, i-CDI desalination, deionization, hydrolysis, dialysis, electrodialysis reversal, and fuel cells, and wherein the carbon has an average pore mouth diameter in the range of 3 to 5 nm achieved with a pore mouth diameter profile from 80% to 100% mesoporous activated carbon and from 0% to 20% macroporous activated carbon.

7. A method of selecting a pore mouth diameter profile in fabricating electrodes for an electrochemical application by:
excluding activated carbon with a pore mouth diameter of less than 2.5 nm,
excluding volume percentages of microporous carbon of more than 30%, and
maximizing the volume percentage of mesoporous activated carbon without a drop in the specific charge passed/mCg⁻¹ of more than 30% based on at least 100 cycles of charging/discharging in a selected electrochemical system.
